(19) United States
(12) Patent Application Publication
(10) Pub. No.: US 2007/0195255 A1
(43) Pub. Date: Aug. 23, 2007

(54) ASSEMBLED SUBSTRATE FOR LIQUID CRYSTAL PANEL, METHOD OF CUTTING THE ASSEMBLED SUBSTRATE, AND LIQUID CRYSTAL PANEL MANUFATURED THEREBY

(75) Inventors: Hyung-Ho Cho, Cheonan-si (KR); Jang-II Kim, Asan-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/566,335

(22) Filed: Dec. 4, 2006

(30) Foreign Application Priority Data
Feb. 22, 2006 (KR) 10-2006-0017358

(51) Int. Cl. G02F 1/1339

(52) U.S. Cl. 349/153

(57) ABSTRACT

An assembled substrate for a liquid crystal panel that may prevent failures to pads, or the like, when transferring the assembled substrate with cutting channels to a predetermined work station, a method of cutting the assembled substrate, and a liquid crystal panel manufactured by the method. The assembled substrate includes a thin film transistor (TFT) mother substrate including a plurality of TFT array substrates corresponding to liquid crystal unit panels, a color filter mother substrate coupled with the TFT mother substrate and including a plurality of color filter substrates corresponding to the liquid crystal unit panels, and dummy seal patterns interposed between the TFT mother substrate and the color filter mother substrate. The dummy seal patterns overlap with cutting channels for cutting the TFT mother substrate or the color filter mother substrate into the liquid crystal unit panels.

### CROSS REFERENCE TO RELATED APPLICATION

This application claims priority from and the benefit of Korean Patent Application No. 10-2006-0017358, filed on Feb. 22, 2006, which is hereby incorporated by reference for all purposes as if fully set forth herein.

### BACKGROUND OF THE INVENTION

1. Field of the Invention

The present invention relates to an assembled substrate for a liquid crystal panel, a method of cutting the assembled substrate, and a liquid crystal panel manufactured using the method. More particularly, the present invention relates to an assembled substrate that may be cut into a plurality of liquid crystal panels, a method of cutting the assembled substrate, and a liquid crystal panel manufactured by the method.

2. Description of the Related Art

Recently, liquid crystal display apparatuses having notable advantages, such as small size, light weight, low power consumption, and so on, have been actively developed. Generally, a liquid crystal display apparatus includes a liquid crystal panel assembly including a liquid crystal panel that displays image data using the optical properties of liquid crystals and a printed circuit board having driving circuit elements for driving the liquid crystal panel, a backlight assembly that supplies light for image display, and a housing unit accommodating the liquid crystal panel assembly and the backlight assembly. Here, the liquid crystal panel includes a thin film transistor (TFT) array substrate, in which TFTs are arranged, a color filter substrate, which includes a common electrode, and a liquid crystal layer interposed between the TFT array and color filter substrates.

A liquid crystal panel may be formed by combining two large transparent substrates (referred to as mother substrates) and cutting the resultant assembled substrate to produce multiple units of liquid crystal panels. The liquid crystal panel includes a TFT array substrate and a color filter substrate. The TFT mother substrate has a plurality of TFT array substrates, and the color filter mother substrate has a plurality of color filter substrates. Edges of the TFT array substrate may include various pads for connecting the TFT array substrate to driving integrated circuits (ICs). The TFT array substrate is larger than the color filter substrate in order to expose the pads.

Typically, a cutting process, which includes scribing and breaking processes, is performed in order to cut an assembled substrate into liquid crystal panels. The scribing process often includes forming cutting channels on the assembled substrate using a diamond wheel. Then, during a transfer process, a conveyor transfers the assembled substrate to a predetermined work station. During the breaking process, the assembled substrate may be cut by applying an impact force thereto. However, when transferring an assembled substrate with cutting channels formed thereon, a fatal failure such as static electricity or a scratch may affect the pads or shorting bars of TFT array substrates, thereby deteriorating the liquid crystal panel's display quality.

### SUMMARY OF THE INVENTION

The present invention provides an assembled substrate for a liquid crystal panel, which may prevent failures to pads, or the like, when transferring the assembled substrate with cutting channels to a predetermined work station.

The present invention also provides a method of cutting the assembled substrate.

The present invention further provides a liquid crystal panel manufactured by the cutting method.

Additional features of the invention will be set forth in the description which follows, and in part will be apparent from the description, or may be learned by practice of the invention.

The present invention discloses an assembled substrate for a liquid crystal panel, including a first mother substrate having a plurality of first substrates corresponding to liquid crystal unit panels, respectively, a second mother substrate coupled with the first mother substrate and having a plurality of second substrates corresponding to the liquid crystal unit panels, respectively, and a dummy seal pattern. The dummy seal pattern is arranged between the first mother substrate and the second mother substrate to overlap with cutting channels for cutting the first mother substrate or the second mother substrate into the liquid crystal unit panels.

The present invention also discloses a method of cutting an assembled substrate for a liquid crystal panel. The method includes forming an assembled substrate that includes a first mother substrate having a plurality of first substrates corresponding to liquid crystal unit panels, respectively. A second mother substrate is coupled with the first mother substrate and includes a plurality of second substrates corresponding to the liquid crystal unit panels, respectively. A dummy seal pattern is arranged between the first mother substrate and the second mother substrate to overlap with cutting channels. The assembled substrate is cut into the liquid crystal unit panels along the cutting channels.

The present invention also discloses a liquid crystal panel including a color filter substrate, a TFT array substrate coupled with the color filter substrate where at least one edge of the TFT array substrate is aligned with at least one edge of the color filter substrate. A dummy seal pattern is arranged between the TFT array substrate and the color filter substrate to overlap with the at least one aligned edge of the TFT array substrate and the color filter substrate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart showing a method of manufacturing a liquid crystal display apparatus according to an exemplary embodiment of the present invention.

FIG. 2 is a detailed flowchart showing a process of cutting an assembled substrate into unit panels in the method of FIG. 1.

FIG. 3 is an exploded perspective view showing an assembled substrate for a liquid crystal panel according to an exemplary embodiment of the present invention.

FIG. 4A is a plan view of the assembled substrate of FIG. 3.

FIG. 4B is a sectional view taken along line H-H′ of FIG. 4A.

FIG. 4C is a perspective view of a liquid crystal panel produced by cutting the assembled substrate of FIG. 4A to yield a liquid crystal unit panel.

FIG. 5A is a plan view showing a modified example of the assembled substrate of FIG. 4A.

FIG. 5B is a perspective view of a liquid crystal panel produced by cutting the assembled substrate of FIG. 5A to yield a liquid crystal unit panel.

FIG. 6A is a plan view showing an assembled substrate for a liquid crystal panel according to another exemplary embodiment of the present invention.

FIG. 6B is a perspective view of a liquid crystal panel produced by cutting the assembled substrate of FIG. 6A to yield a liquid crystal unit panel.

FIG. 7A is a plan view showing a modified example of the assembled substrate of FIG. 6A.

FIG. 7B is a perspective view of a liquid crystal panel produced by cutting the assembled substrate of FIG. 7A to yield a liquid crystal unit panel.

### DETAILED DESCRIPTION OF THE ILLUSTRATED EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

A liquid crystal display apparatus of the present invention includes a liquid crystal panel assembly, a backlight assembly, and a housing unit. The liquid crystal panel assembly includes a liquid crystal panel to display image data using liquid crystals and a printed circuit board having driving circuit elements for driving the liquid crystal panel. The backlight assembly supplies the liquid crystal display apparatus with light for image display. The housing unit fixedly receives the liquid crystal panel assembly and the backlight assembly. The liquid crystal panel includes a thin film transistor (TFT) array substrate, in which TFTs are arranged, a color filter substrate, which includes a common electrode, and a liquid crystal layer interposed between the TFT array and color filter substrates. Various pads for connecting the TFT array substrate to driving integrated circuits (ICs) for driving the liquid crystal panel are arranged at edges of the TFT array substrate, which is larger than the color filter substrate to expose the pads. A chassis, a mold frame, or the like, may be used as the housing unit.

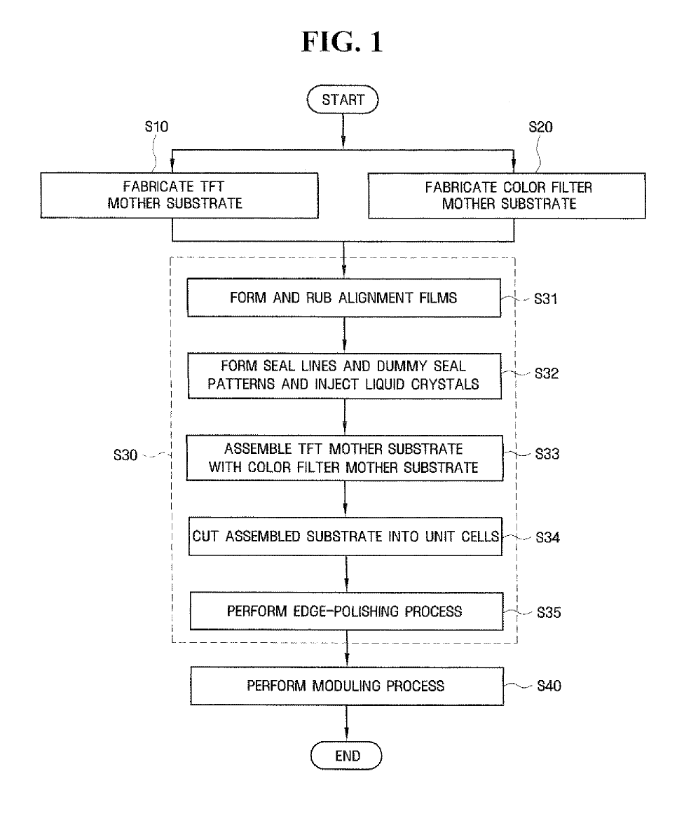

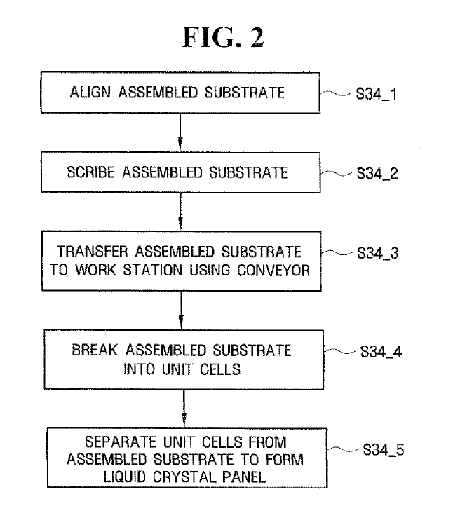

A method of manufacturing a liquid crystal display apparatus according to an exemplary embodiment of the present invention will be described below with reference to FIG. 1 and FIG. 2.

FIG. 1 is a flowchart showing a method of manufacturing the liquid crystal display apparatus according to an exemplary embodiment of the present invention, and FIG. 2 is a flowchart showing details of a process of cutting an assembled substrate into unit panels.

Referring to FIG. 1, the method of manufacturing the liquid crystal display apparatus includes a TFT mother substrate fabrication process (operation S10), a color filter mother substrate fabrication process (operation S20), a liquid crystal cell forming process (operation S30), and a module forming process (operation S40).

In operation S10, a TFT mother substrate is fabricated on a large glass substrate having a TFT array substrate formed in each liquid crystal unit panel. In operation S20, a color filter mother substrate is fabricated on another large glass substrate having a color filter substrate formed in each liquid crystal unit panel. Thus, the TFT mother substrate and the color filter mother substrate include a plurality of TFT array substrates and a plurality of color filter substrates defined by liquid crystal unit panels, respectively.

The TFT mother substrate and color filter mother substrate are subjected to a liquid crystal cell forming process S30. Operation S30 includes forming alignment films and seal lines on the two mother substrates to define a plurality of liquid crystal unit panels, injecting liquid crystals into the liquid crystal unit panels, combining the two mother substrates into an assembled substrate, and cutting the resulting assembled substrate into individual liquid crystal unit panels by means of a variety of cutting tools to produce the liquid crystal panels.

Thereafter, the module forming process is performed S40. In this process, driving circuits for supplying electrical signals to the liquid crystal panel are coupled with the liquid crystal panel.

A detailed process flow of the liquid crystal cell forming process (operation S30) of FIG. 1 is described below.

As shown in FIG. 1, the liquid crystal cell forming process (operation S30) includes a process of forming and rubbing alignment films (operation S31), a process of forming seal lines and dummy seal patterns on the two mother substrates to define a plurality of liquid crystal unit panels and a process of injecting liquid crystals (operation S32), an assembled substrate assembling process (operation S33), a cutting process (operation S34), and an edge-polishing process (operation S35).

In operation S31, an alignment film is formed to a predetermined thickness on pixel electrodes of the TFT mother substrate and a common electrode of the color filter mother substrate and then uniformly rubbed. Therefore, liquid crystal molecules may be arranged at substantially uniform distances, thereby ensuring substantially uniform display characteristics throughout the entire screen.

The alignment film should adhere well with an electrode material, such as indium tin oxide (ITO), and it should have film uniformity of 1,000 Å or less at 200 Å or less. Also, the alignment film should have sufficient chemical stability so as not to react with liquid crystals, it should not function as electrical charge trapping media, and it should have sufficiently high resistivity so it does not affect the driving of the liquid crystals. In view of these characteristics, a polyimide-based polymer material may serve as a suitable alignment film.

When rubbing the alignment films, they may be rubbed in one direction using a cotton- or nylon-piled soft cloth so that liquid crystal molecules may be arranged in a predetermined direction. For example, with respect to a twisted nematic (TN)-mode liquid crystal panel, an alignment film of the TFT array substrate is rubbed in a direction that is perpendicular to that of the color filter substrate.

After completing operation S31, seal lines may be formed along edges of display regions of liquid crystal unit panels defined in the TFT mother substrate to firmly attach TFT array substrates with color filter substrates and to receive liquid crystals in operation S32.

Here, the seal lines may be formed using a sealant, which is an adhesive for attaching the TFT array substrate and the color filter substrate, and a seal material including spacers for securing a liquid crystal receiving space.

In order to uniformly maintain cell gaps between the TFT array substrate and the color filter substrate, the spacers may be provided in active regions of the liquid crystal panel, as well as in the seal lines at periphery regions of screens.

When the seal lines are formed, dummy seal patterns may also be formed on predetermined regions between the TFT mother substrate and the color filter mother substrate except on display regions of the liquid crystal panel. The dummy seal patterns serve to prevent the assembled substrate, composed of the TFT mother substrate and the color filter mother substrate, from breaking when transferring it to a predetermined work station in operation S34.

After forming the seal lines and the dummy seal patterns, liquid crystals may be injected onto the color filter mother substrate in operation S32. Alternatively, liquid crystals may be injected between TFT array substrates and color filter substrates using vacuum pressure. The dummy seal patterns may be made of the same material as the seal lines.

The TFT mother substrate with the seal lines and the color filter mother substrate with the liquid crystals are then aligned and treated with ultraviolet (UV) light or heat to cure the seal lines to assemble the TFT mother substrate and the color filter mother substrate in operation S33. An allowance error for alignment of the two mother substrates may be determined by a design margin of the two mother substrates, or the like.

The resultant assembled substrate is cut into liquid crystal unit panels to produce liquid crystal panels in operation S34. Here, a diamond wheel, or the like, may be used.

Referring to FIG. 2, which shows a detailed process flow of the cutting process of operation S34 of FIG. 1, the assembled substrate produced in operation S33 is first aligned in a scribe unit in operation S34_1. Then, the scribing operation is performed to form cutting channels for each liquid crystal unit panel on the assembled substrate using a diamond wheel, or the like, in operation S34_2. The assembled substrate with the cutting channels may then be transferred to a steam break unit by means of a conveyor in operation S34_3. Here, the dummy seal patterns overlap with the cutting channels to prevent the assembled substrate from being cut due to impact when transferring the assembled substrate to the steam break unit, thereby preventing failure to pads and shorting bars on the TFT mother substrate, which will be described in detail below.

Vapor pressure may be applied to the assembled substrate in the steam break unit to cut the assembled substrate along the cutting channels to produce liquid crystal unit panels in operation S34_4. The liquid crystal unit cells are separated from the corresponding assembled substrate to complete individual liquid crystal panels composed of a TFT array substrate and a color filter substrate in operation S34_5.

Turning to FIG. 1, with respect to the edge-polishing process in operation S35, sides and edges of the TFT array substrate and the color filter substrate may be polished by rotating a diamond polishing stone over the sides and edges at high speed.

Polarization plates may then be respectively attached to front and rear surfaces of each liquid crystal panel. The electro-optical characteristics and image quality of the thus-completed liquid crystal panel are then inspected. For example, the electro-optical characteristics of the liquid crystal panel may be inspected by applying test signals to shorting bars commonly connected to gate lines and data lines.

The liquid crystal panel may then be subjected to the module forming process in operation S40. Operation S40 includes mounting a driving IC on the liquid crystal panel, attaching a printed circuit board (PCB) to the liquid crystal panel, and assembling the liquid crystal panel with a backlight assembly using a mold frame, chassis, or the like.

Here, the driving IC may be mounted on the liquid crystal panel using technology such as tape automated bonding (TAB), chip on board (COB), or chip on glass (COG). The PCB includes a multi-layered circuit device and may be electrically connected to the driving IC via a flexible printed circuit (FPC), or the like to constitute the driving circuit units of a liquid crystal display. The PCB may be formed using surface mount technology (SMT), or the like, and then attached to the liquid crystal panel. The liquid crystal panel with the driving ICs and the PCB is called a “liquid crystal panel assembly.”

The liquid crystal panel assembly, together with a separately formed backlight assembly, may be received in a mold frame or chassis to complete a liquid crystal display.

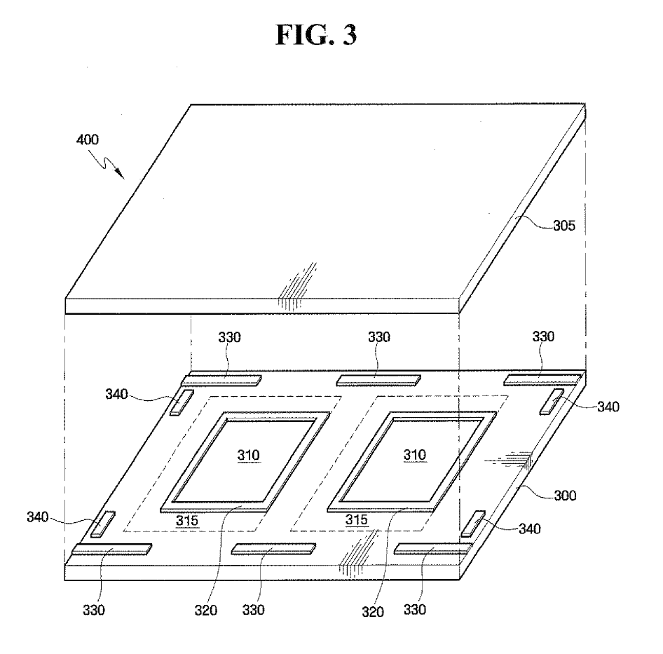

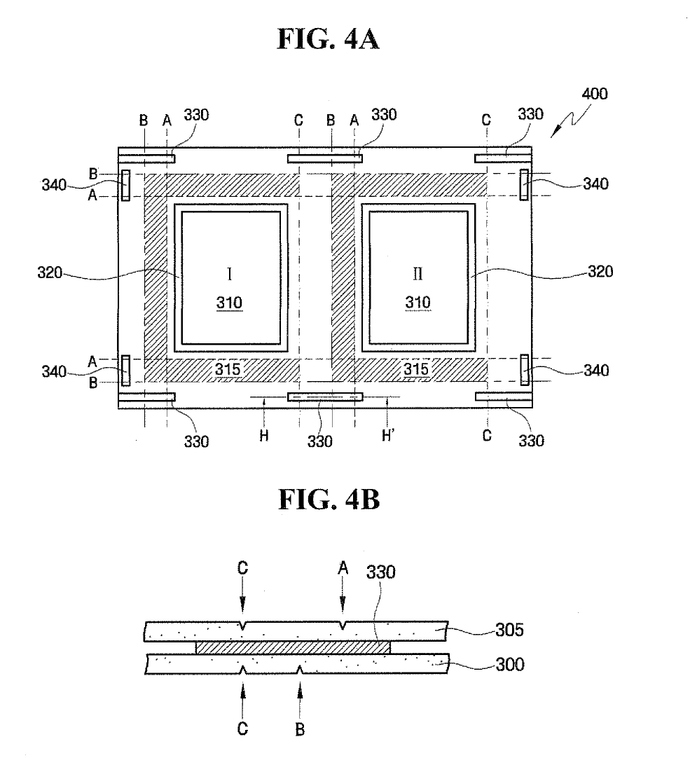

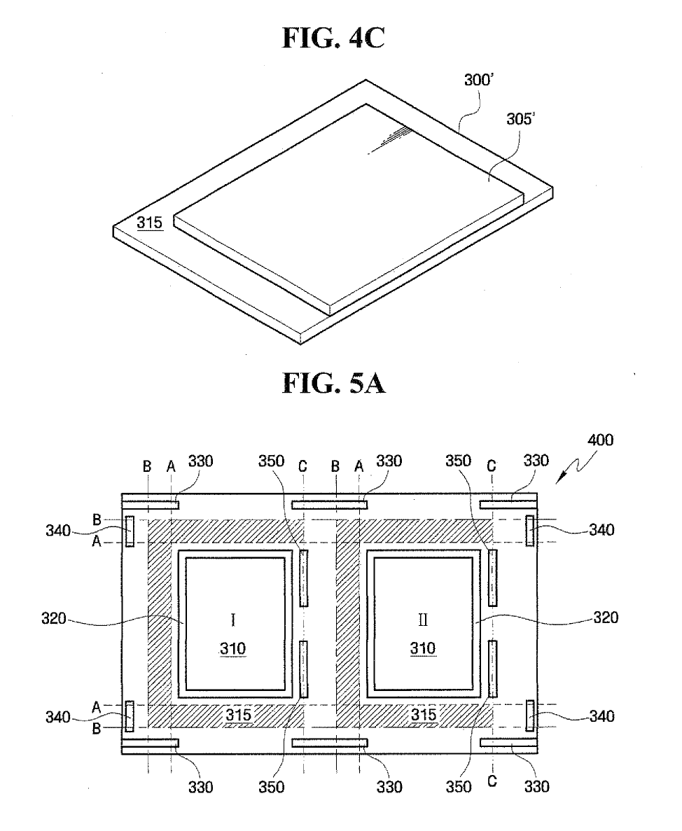

An assembled substrate for a liquid crystal panel according to an exemplary embodiment of the present invention will be described below with reference to FIG. 3, FIG. 4A, FIG. 4B, and FIG. 4C.

FIG. 3 is an exploded perspective view showing an assembled substrate for a liquid crystal panel according to an exemplary embodiment of the present invention. FIG. 4A is a plan view of the assembled substrate of FIG. 3, FIG. 4B is a sectional view taken along line H-H′ of FIG. 4A, and FIG. 4C is a perspective view of a liquid crystal panel produced by cutting the assembled substrate of FIG. 4A to produce a liquid crystal unit panel.

Referring to FIG. 3, FIG. 4A, FIG. 4B, and FIG. 4C, an assembled substrate 400 for a liquid crystal panel is composed of a pair of large transparent substrates, i.e., a TFT mother substrate 300 and a color filter mother substrate 305 that oppose and face each other. The assembled substrate 400 includes a plurality of liquid crystal unit panels (i.e. at least two liquid crystal unit panels). While the current embodiment of the present invention is described in terms of the assembled substrate 400 including two liquid crystal unit panels I and II, the assembled substrate 400 may have more than two liquid crystal unit panels.

The liquid crystal unit panels I and II individually include a TFT array substrate 300′ and a color filter substrate 305′.

That is, the TFT mother substrate 300 includes a TFT array substrate 300′ in each liquid crystal unit panel I and II. A driving IC-connecting area 315, in which driving ICs (not shown) may be mounted, is disposed in a “U”-shaped form along outer edges of display regions 310 of the TFT array substrates 300′. The driving ICs for driving the liquid crystal unit panels I and II are connected to the TFT array substrates 300′. For this, predetermined pads (not shown) may be disposed on the driving IC-connecting area 315. Thus, the color filter substrates 305′ may be smaller than the TFT array substrates 300′ so that the driving IC-connecting area 315 may be exposed.

The driving ICs include a gate driving IC (not shown) and a data driving IC (not shown). The driving IC-connecting area 315 includes a gate driving IC-connecting area and a data driving IC-connecting area corresponding to the gate driving ICs and the data driving ICs, respectively. For example, the gate driving IC-connecting area may be disposed at the shorter sides of the liquid crystal unit panels I and II, and the data driving IC-connecting area may be disposed at the longer side of the liquid crystal unit panels I and II.

As shown in FIG. 4A, FIG. 4B, and FIG. 4C, in order to cut the assembled substrate 400 into the liquid crystal unit panels I and II, cutting channels A, B, and C are formed on the assembled substrate 400 using a scribing process. Since the TFT array substrates 300′ and the color filter substrates 305′ have different sizes, the cutting channels A, B, and C are formed at different positions.

For example, as shown in the embodiment of FIGS. 3 through 4C, where the driving IC-connecting area 315 is disposed along three outer edges of the display regions 310, the cutting channels C are formed vertically along the driving IC-connecting-area-free outer edges of the display regions 310 in both the TFT mother substrate 300 and the color filter mother substrate 305. The cutting channels A are formed both vertically and horizontally along boundaries between the display regions 310 and the driving IC-connecting area 315 in the color filter mother substrate 305. The cutting channels B are formed both vertically and horizontally along outer edges of the driving IC-connecting area 315 in the TFT mother substrate 300.

In order to prevent an assembled substrate with cutting channels A, B, and C from breaking while transferring it to a steam break unit, first dummy seal patterns 330 and second dummy seal patterns 340 may be disposed along edges of the assembled substrate 400. The first dummy seal patterns 330 and the second dummy seal patterns 340 are interposed between the TFT mother substrate 300 and the color filter mother substrate 305, like seal lines 320. The first dummy seal patterns 330 overlap with ends of the vertical cutting channels A, B, and C, and the second dummy seal patterns 340 overlap with ends of the horizontal cutting channels A and B.

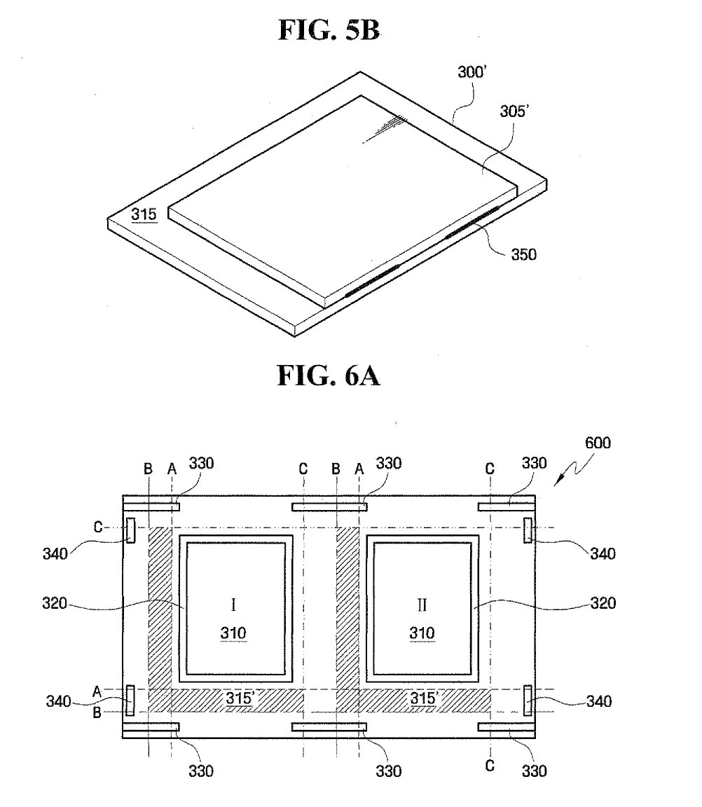

A modified example of the assembled substrate 400 will be described below with reference to FIG. 5A and FIG. 5B.

FIG. 5A is a plan view showing a modified example of the assembled substrate of FIG. 4A, and FIG. 5B is a perspective view of a liquid crystal panel produced by cutting the assembled substrate of FIG. 5A to yield a liquid crystal unit panel. For brevity, the same reference numerals denote the same elements in FIGS. 4A through 4C, and thus further description of the same elements will be omitted.

Referring to FIG. 5A, the assembled substrate 400 further includes third dummy seal patterns 350 disposed along cutting channels C so as to overlap with the cutting channels C. The third dummy seal patterns 350 may be formed in the same process together with seal lines 320. Since the cutting channels C are formed on both a TFT mother substrate (not shown) and a color filter mother substrate (not shown), the assembled substrate 400 may easily be cut out along the cutting channels C by slight external impact. Here, it is possible to more effectively prevent the assembled substrate 400 from being cut during the transfer process by forming the third dummy seal patterns 350 along the cutting channels C, which are particularly vulnerable to external impact.

Referring to FIG. 5B, a driving IC-connecting area 315 is disposed in a “U”-shaped form along edges of a TFT array substrate 300′ that are exposed by a color filter substrate 305′. A driving IC-connecting-area-free edge of the TFT array substrate 300′ is aligned with a corresponding edge of the color filter substrate 305′, and third dummy seal patterns 350 overlap with the aligned edge of the TFT array substrate 300′ and the color filter substrate 305′.

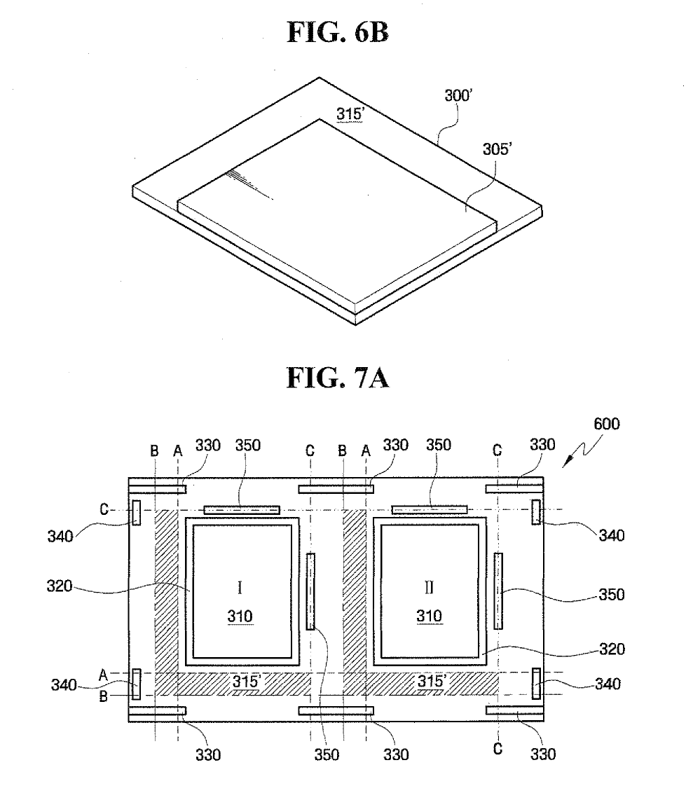

An assembled substrate for a liquid crystal panel according to another exemplary embodiment of the present invention will be described below with reference to FIG. 6A and FIG. 6B.

FIG. 6A is a plan view showing an assembled substrate 600 for a liquid crystal panel according to another exemplary embodiment of the present invention. FIG. 6B is a perspective view of the liquid crystal panel produced by cutting the assembled substrate 600 of FIG. 6A to yield liquid crystal unit panels. For brevity, the same reference numerals denote the same elements in FIGS. 3 through 4C, and thus any further description of the same elements will be omitted.

Referring to FIG. 6A and FIG. 6B, the assembled substrate 600 is composed of a pair of large transparent substrates, i.e., a TFT mother substrate and a color filter mother substrate that oppose and face each other. A driving IC-connecting area 315′ is disposed in an “L”-shaped form along the outer edges of display regions 310 of TFT array substrates 300′. The driving ICs include gate driving ICs (not shown) and data driving ICs (not shown). The driving IC-connecting area 315′ includes a gate driving IC-connecting area and a data driving IC-connecting area corresponding to the gate driving ICs and the data driving ICs, respectively. For example, the gate driving IC-connecting area may be disposed at the shorter side of liquid crystal unit panels I and II, and the data driving IC-connecting area may be disposed at the longer side of the liquid crystal unit panels I and II.

As shown in the current embodiment of the present invention, when the driving IC-connecting area 315′ is disposed along two outer edges of each display region 310, vertical and horizontal cutting channels C are formed along driving IC-connecting-area-free outer edges of the display regions 310 in both the TFT mother substrate and the color filter mother substrate. Vertical and horizontal cutting channels A are formed along boundaries between the display regions 310 and the driving IC-connecting area 315′ in the color filter mother substrate, and vertical and horizontal cutting channels B are formed along outer edges of the driving IC-connecting area 315′ in the TFT mother substrate.

In order to prevent an assembled substrate with cutting channels A, B, and C from breaking while transferring it to a steam break unit, first dummy seal patterns 330 and second dummy seal patterns 340 may be disposed along edges of the assembled substrate 600. The first dummy seal patterns 330 and the second dummy seal patterns 340 are interposed between the TFT mother substrate and the color filter mother substrate, like seal lines 320. The first dummy seal patterns 330 overlap with ends of the vertical cutting channels A, B, and C, and the second dummy seal patterns 340 overlap with the ends of the horizontal cutting channels A, B, and C.

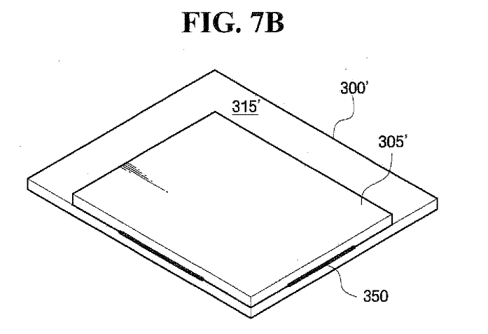

A modified example of the assembled substrate 600 will be described below with reference to FIG. 7A and FIG. 7B.

FIG. 7A is a plan view showing a modified example of the assembled substrate 600 of FIG. 6A, and FIG. 7B is a perspective view of a liquid crystal panel produced by cutting the assembled substrate 600 of FIG. 7A to yield liquid crystal unit panels. For brevity, the same reference numerals denote the same elements in FIG. 6A and FIG. 6B, and thus further description of the same elements will be omitted.

Referring to FIG. 7A, the assembled substrate 600 further includes third dummy seal patterns 350 formed so as to overlap with the vertical and horizontal cutting channels C. The cutting channels C may be formed along outer edges of display regions 310, and the third dummy seal patterns 350 may overlap with the cutting channels C disposed adjacent to the display regions 310, as shown in FIG. 7A. In alternative embodiment, the third dummy seal patterns 350 may overlap with either the horizontal cutting channel C or the vertical cutting channel C.

Furthermore, the third dummy seal patterns 350 may be formed in the same process together with seal lines 320. Since the cutting channels C are formed on both a TFT mother substrate and a color filter mother substrate, the assembled substrate 600 may be easily cut along the cutting channels C by slight external impact. Here, the third dummy seal patterns 350 are formed along the cutting channels C, which are particularly vulnerable to external impact, thereby effectively preventing the assembled substrate 600 from being cut when transferring it to a steam break unit.

Referring to FIG. 7B, a driving IC-connecting area 315′ is disposed in an “L”-shaped form along edges of a TFT array substrate 300′ exposed by a color filter substrate 305′. Driving IC-connecting-area-free edges of the TFT array substrate 300′ are aligned with corresponding edges of the color filter substrate 305′, and third dummy seal patterns 350 overlap with the aligned edges of the TFT array substrate 300′ and the color filter substrate 305′.

As described above, exemplary embodiments of the present invention provide an assembled substrate for a liquid crystal panel, a method of cutting the assembled substrate, and a liquid crystal panel manufactured by the method. According to the present invention, failures to pads, or the like, may be prevented when transferring an assembled substrate with cutting channels to a predetermined work station, thereby reducing manufacturing costs of liquid crystal displays.

While the present invention has been particularly shown and described with reference to exemplary embodiments thereof, it will be apparent to those skilled in the art that the scope of the invention is given by the appended claims, rather than the preceding description, and all variations and equivalents which fall within the range of the claims are intended to be embraced therein. Therefore, it should be understood that the above embodiments are not limiting, but illustrative in all aspects.

What is claimed is:

1. An assembled substrate, comprising:
a first mother substrate comprising a plurality of first substrates for a plurality of liquid crystal unit panels;
a second mother substrate coupled with the first mother substrate and comprising a plurality of second substrates for the plurality of liquid crystal unit panels;
cutting channels arranged on the assembled substrate for cutting the first mother substrate or the second mother substrate into the liquid crystal unit panels; and
a dummy seal pattern arranged between the first mother substrate and the second mother substrate, the dummy seal pattern overlapping with the cutting channels.

2. The assembled substrate of claim 1, wherein the cutting channels comprise first cutting channels for cutting the first mother substrate and second cutting channels for cutting the second mother substrate, and
wherein the dummy seal pattern overlaps with ends of the first cutting channels and the second cutting channels.

3. The assembled substrate of claim 2, wherein the dummy seal pattern comprises a first dummy seal pattern overlapping with ends of vertical cutting channels of the first cutting channels and the second cutting channels, and a second dummy seal pattern overlapping with ends of horizontal cutting channels of the first cutting channels and the second cutting channels.

4. The assembled substrate of claim 1, wherein the cutting channels comprise first cutting channels arranged at the same locations on both the first mother substrate and the second mother substrate, and
wherein the dummy seal pattern comprises a first dummy seal pattern overlapping with the first cutting channels, the first dummy seal pattern being arranged along the first cutting channels.

5. The assembled substrate of claim 4, wherein driving integrated circuit (IC)-connecting area is disposed along edges of each first substrate, and the first cutting channels are arranged along a driving IC-connecting-area-free side of each first substrate.

6. The assembled substrate of claim 5, wherein the driving IC-connecting area comprises a gate driving IC-connecting area disposed at a shorter side of each first substrate and a data driving IC-connecting area disposed at a longer side of each first substrate.

7. The assembled substrate of claim 1, wherein the dummy seal pattern overlaps with ends of the cutting channels.

8. The assembled substrate of claim 7, wherein the dummy seal pattern is disposed along edges of the assembled substrate.

9. The assembled substrate of claim 1, further comprising:
seal lines disposed between the first mother substrate and the second mother substrate, the seal lines being arranged along edges of display regions to seal each first substrate and each second substrate,
wherein the dummy seal pattern is made of the same material as the seal lines.

10. A method of forming and cutting an assembled substrate, comprising:
forming an assembled substrate, wherein forming the assembled substrate comprises:
forming a first mother substrate comprising a plurality of first substrates for a plurality of liquid crystal unit panels;
coupling a second mother substrate with the first mother substrate, the second mother substrate comprising a plurality of second substrates for the plurality of liquid crystal unit panels; and
arranging a dummy seal pattern between the first mother substrate and the second mother substrate, the dummy seal pattern overlapping with cutting channels; and
cutting the assembled substrate into the liquid crystal unit panels along the cutting channels.

11. The method of claim 10, wherein the cutting channels comprise first cutting channels for cutting the first mother substrate and second cutting channels for cutting the second mother substrate, and the dummy seal pattern overlaps with ends of the first cutting channels and the second cutting channels.

12. The method of claim 11, wherein the dummy seal pattern comprises a first dummy seal pattern overlapping with ends of vertical cutting channels of the first cutting channels and the second cutting channels, and a second dummy seal pattern overlapping with ends of horizontal cutting channels of the first cutting channels and the second cutting channels.

13. The method of claim 10, wherein the cutting channels comprise first cutting channels arranged at the same locations on both the first mother substrate and the second mother substrate, and
wherein the dummy seal pattern comprises a first dummy seal pattern overlapping with the first cutting channels, the first dummy seal pattern being arranged along the first cutting channels.

14. The method of claim 13, wherein a driving integrated circuit (IC)-connecting area is disposed along edges of each first substrate, and the first cutting channels are arranged along a driving IC-connecting-area-free side of each first substrate.

15. The method claim 14, wherein the driving IC-connecting area comprises a gate driving IC-connecting area disposed at a shorter side of each first substrate and a data driving IC-connecting area disposed at a longer side of each first substrate.

16. The method of claim 10, wherein the dummy seal pattern overlaps with ends of the cutting channels.

17. The method of claim 16, wherein the dummy seal pattern is disposed along edges of the assembled substrate.

18. The method of claim 10, wherein the assembled substrate further comprises seal lines disposed between the first mother substrate and the second mother substrate, the seal lines being arranged along edges of display regions to seal the first substrates and the second substrates, and
wherein the dummy seal pattern is made of the same material as the seal lines.

19. A liquid crystal panel, comprising:
a color filter substrate;
a TFT array substrate coupled with the color filter substrate, at least one edge of the TFT array substrate being aligned with at least one edge of the color filter substrate; and
a dummy seal pattern arranged between the TFT array substrate and the color filter substrate, the dummy seal pattern overlapping with the at least one aligned edge of the TFT array substrate and the color filter substrate.

20. The liquid crystal panel of claim 19, wherein a driving IC-connecting area is disposed along an edge of the TFT array substrate that is exposed by the color filter substrate, and
wherein the dummy seal pattern is disposed along a driving IC-connecting-area-free edge of the TFT array substrate.

21. The liquid crystal panel of claim 19, further comprising:
a seal line disposed between the TFT array substrate and the color filter substrate, the seal line being arranged along an outer edge of a display region to seal the TFT array substrate and the color filter substrate,
wherein the dummy seal pattern is made of the same material as the seal line.
